(19) United States
(12) Patent Application Publication
(10) Pub. No.: US 2026/0039753 A1
(43) Pub. Date: Feb. 5, 2026

(54) MULTIPLE CONCURRENT CONFERENCE CALLS

(71) Applicant: Dell Products L.P., Round Rock, TX (US)

(72) Inventors: Danilo O. TAN, Austin, TX (US); Karunakar POOSAPALLI, Telangana (IN); Swagat PARIDA, Bangalore (IN); Shekar Babu SURYANARAYANA, Bangalore (IN)

(73) Assignee: Dell Products L.P., Round Rock, TX (US)

(21) Appl. No.: 18/791,054

(22) Filed: Jul. 31, 2024

(51) Int. Cl. H04M 3/56; G06F 3/16

(52) U.S. Cl. CPC H04M 3/563; H04M 3/568; G06F 3/165

(57) ABSTRACT

An information handling system may include at least one processor, a memory, and an audio input device. The information handling system may be configured to: execute at least one conference call application, wherein the at least one conference call application is configured to join a plurality of concurrent conference calls; determine one of the plurality of concurrent conference calls as a foreground call; raise a volume level of the foreground call relative to another of the plurality of concurrent conference calls; and transmit audio input from the audio input device to the foreground call.

### TECHNICAL FIELD

The present disclosure relates in general to information handling systems, and more particularly to managing multiple concurrent conference calls (e.g., videoconference and/or audioconference calls).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A user of an information handling system may use it to participate in a conference call. This is typically accomplished via the use of one or more applications such as Zoom®, Microsoft® Teams®, Google® Talk®, Skype®, etc. Sometimes a user's schedule may dictate that more than one such conference call must take place concurrently (e.g., two calls that use the same application, two calls using different applications, more than two calls, etc.). For the purposes of this disclosure, the term “conference call” should be understood to encompass communications sessions on an information handling system that use audio and/or video in which two or more individuals are present.

Currently it is difficult for the user to manage multiple conference calls. For example, the user may have difficulty controlling the audio/video settings efficiently, and the information handling system has no way of determining which call is most important at any given time. Embodiments of this disclosure provide improvements in this field.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with multiple concurrent conference calls may be reduced or eliminated.

In accordance with embodiments of the present disclosure, an information handling system may include at least one processor, a memory, and an audio input device. The information handling system may be configured to: execute at least one conference call application, wherein the at least one conference call application is configured to join a plurality of concurrent conference calls; determine one of the plurality of concurrent conference calls as a foreground call; raise a volume level of the foreground call relative to another of the plurality of concurrent conference calls; and transmit audio input from the audio input device to the foreground call.

In accordance with these and other embodiments of the present disclosure, a method may include, in an information handling system including an audio input device: the information handling system executing at least one conference call application, wherein the at least one conference call application is configured to join a plurality of concurrent conference calls; the information handling system determining one of the plurality of concurrent conference calls as a foreground call; the information handling system raising a volume level of the foreground call relative to another of the plurality of concurrent conference calls; and the information handling system transmitting audio input from the audio input device to the foreground call.

In accordance with these and other embodiments of the present disclosure, an article of manufacture may include a non-transitory, computer-readable medium having computer-executable instructions thereon that are executable by a processor of an information handling system, wherein the information handling system includes an audio input device, the instructions being executable for: executing at least one conference call application, wherein the at least one conference call application is configured to join a plurality of concurrent conference calls; determining one of the plurality of concurrent conference calls as a foreground call; raising a volume level of the foreground call relative to another of the plurality of concurrent conference calls; and transmitting audio input from the audio input device to the foreground call.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example architecture conference call management, in accordance with embodiments of the present disclosure; and FIG. 3 illustrates an example conference call management agent, in accordance with embodiments of the present disclosure.

### DETAILED DESCRIPTION

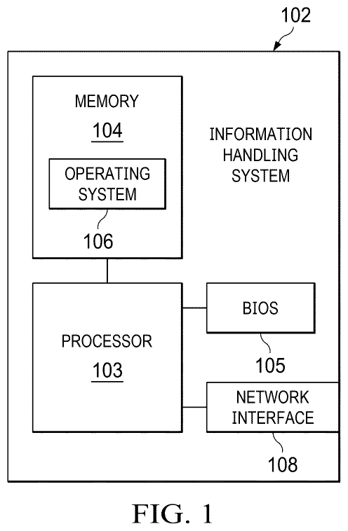

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, a user of information handling system 102 may sometimes participate in multiple conference calls concurrently. Embodiments of this disclosure address the difficulties that may arise in such a situation.

Some embodiments may be implemented for Microsoft® Windows® using the Audio Processing Object (APO) architecture, as will be understood by one of ordinary skill in the art with the benefit of this disclosure. Various acronyms mentioned in this disclosure are used in that architecture, such as APO (audio processing object), SFX (stream effects), MFX (mode effects), and EFX (endpoint effects). More details about the APO architecture are described in a document that is attached to the present disclosure as an Information Disclosure Statement. One of ordinary skill in the art with the benefit of this disclosure will appreciate that other implementations may be based on different operating systems and/or architectures as well.

When multiple conference calls are taking place concurrently, embodiments of this disclosure allow the information handling system to select the highest priority call and make it the foreground call, putting other calls into the background. The foreground call may have its volume raised relative to background calls, microphone input may be routed to the foreground call, the window of the foreground call may be raised to the top of the stack of a window manager, keyboard/mouse input may be routed to the foreground call, and/or any other suitable action may be taken to make the foreground call more prominent for the user.

Embodiments provide context-based application switching, and may operate with multiple instances of a single application and/or instances of multiple separate applications.

For example, embodiments may cause the different calls to seamlessly switch between background and foreground states. In instances where a user engages in more than one call, embodiments may detect the active and inactive calls, adjusting the foreground/background state of each application accordingly. For users who are prioritizing a specific call as primary, embodiments may lower the volume of the secondary call to maintain focus. The user's ability to listen in the background call ensures continuous awareness of other call, with the flexibility to switch when attention is required.

Additionally, embodiments may detect events in background calls that may be indicative of the need to switch to the foreground. For example, if someone in a background call mentions the user's name or certain other predetermined keywords, the user may be notified and/or the background call may be automatically raised to the foreground. Embodiments may also use speech-to-text techniques to provide transcripts of calls (e.g., foreground and/or background calls).

Embodiments may be implemented via a runtime virtual agent for managing conference calls to determine and store the context of a user's current calls. The agent may implement callback methods from individual application software development kits (SDKs) and fetch the configuration and settings of individual applications audio and video control settings.

Embodiments thus may implement the logic for identifying the most important active conference call application with the help of various input parameters.

Embodiments may also create a configuration database to store various configuration settings as described herein, which may be cloud-based or stored offline.

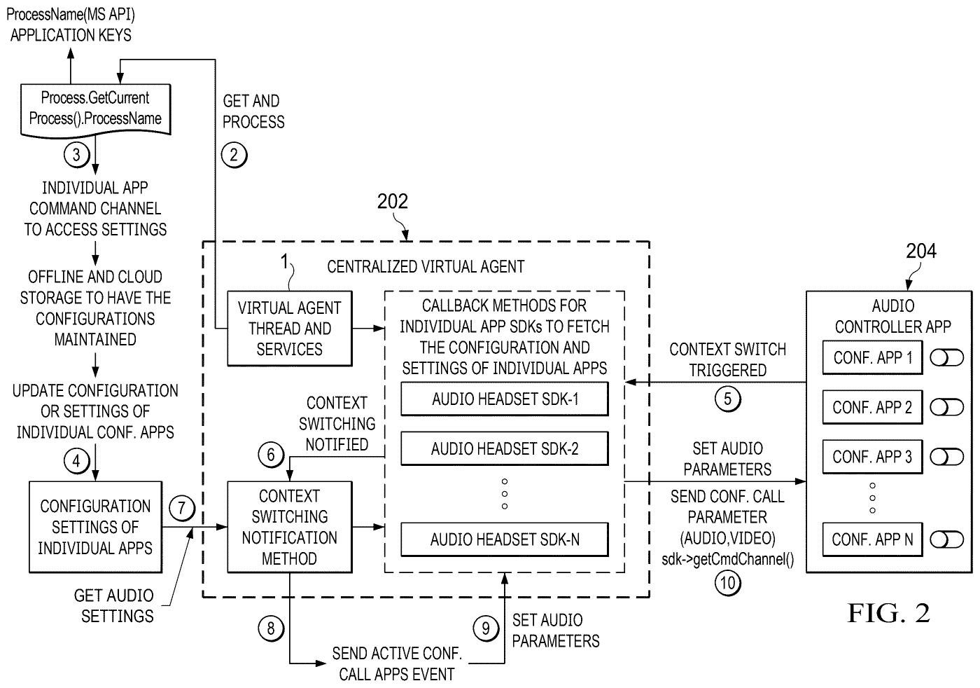

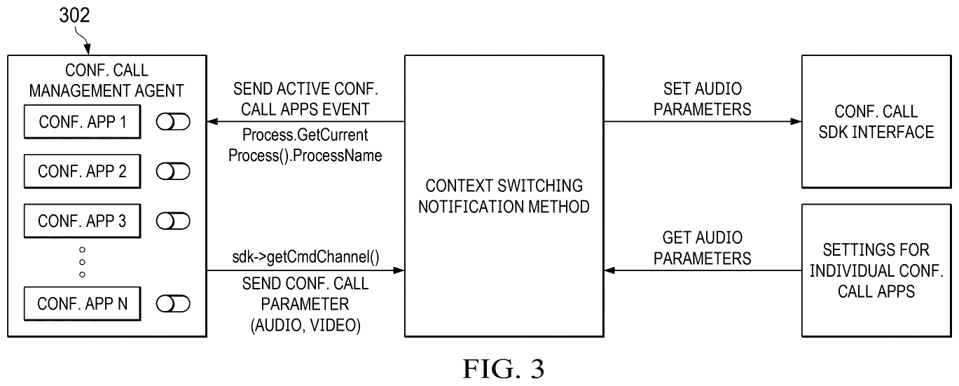

FIG. 2 illustrates an example architecture, according to some embodiments. As shown, a centralized virtual agent 202 manages the interactions between the various conference call applications and the audio SDKs. A user-facing audio controller app 204 also provides manual control.

Centralized virtual agent 202 may determine which conference call applications are in use by enumerating the names of running processes (e.g., with a function call such as Process.GetCurrentProcess( ).ProcessName). The results may be compared against a stored set of names and/or keywords to determine which processes correspond to conference call applications that can be managed.

In one embodiment, a method may build intelligence to handle multiple conference call applications and switch the background/foreground context automatically. Some embodiments may also integrate with a conference touch panel (CTP) in addition or alternatively to using the information handling system's main monitor display.

For example, if a user attempts to perform some action (e.g., unmuting an audio input device such as a microphone) with respect to a given conference call application, some embodiments may pop up a confirmation message to confirm that the interaction is being routed correct application.

Embodiments also provide tools for determining the context of different conference call applications. FIG. 3 shows further details of the operation of conference call management agent 302, similar to conference call management agent 202 from FIG. 2.

As shown, conference call management agent 302 may determine and store the context of the user's currently running conference call applications. Embodiments may implement callback methods from individual application SDKs and fetch the configuration and settings (e.g., audio/video settings) of those individual applications. Embodiments may implement the logic for identifying the active conference call application that should be placed in the user's foreground. Some embodiments also implement a configuration database (e.g., a local offline database and/or a cloud-based database) to store the configuration settings for the various conference call applications. For example, the user's desired configurations for each application may be stored in the database, and any changes the user makes may be propagated to the database. When needed, the settings may be recalled from the database and implemented via the application SDKs.

One of ordinary skill in the art with the benefit of this disclosure will understand that the preferred initialization point for the methods depicted in FIGS. 2 and 3 and the order of the steps comprising those methods may depend on the implementation chosen. In these and other embodiments, these methods may be implemented as hardware, firmware, software, applications, functions, libraries, or other instructions. Further, although FIGS. 2 and 3 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory; and
an audio input device;
wherein the information handling system is configured to:
execute at least one conference call application, wherein the at least one conference call application is configured to join a plurality of concurrent conference calls;
determine one of the plurality of concurrent conference calls as a foreground call;
raise a volume level of the foreground call relative to another of the plurality of concurrent conference calls; and
transmit audio input from the audio input device to the foreground call.

2. The information handling system of claim 1, wherein the at least one conference call application comprises a plurality of different conference call applications.

3. The information handling system of claim 1, wherein the at least one conference call application comprises a plurality of instances of a single conference call application.

4. The information handling system of claim 1, further configured to:
receive user input relating to settings for the at least one conference call application;
store the user input in a database; and
transmit the user input to the at least one conference call application.

5. The information handling system of claim 1, further configured to determine a different one of the plurality of concurrent conference calls as a new foreground call based on content of the different one of the plurality of concurrent conference calls.

6. The information handling system of claim 5, wherein the content comprises an audible mention of a name of a user of the information handling system.

7. A method comprising, in an information handling system including an audio input device:
the information handling system executing at least one conference call application, wherein the at least one conference call application is configured to join a plurality of concurrent conference calls;
the information handling system determining one of the plurality of concurrent conference calls as a foreground call;
the information handling system raising a volume level of the foreground call relative to another of the plurality of concurrent conference calls; and
the information handling system transmitting audio input from the audio input device to the foreground call.

8. The method of claim 7, wherein the at least one conference call application comprises a plurality of different conference call applications.

9. The method of claim 7, wherein the at least one conference call application comprises a plurality of instances of a single conference call application.

10. The method of claim 7, further comprising:
the information handling system receiving user input relating to settings for the at least one conference call application;
the information handling system storing the user input in a database; and
the information handling system transmitting the user input to the at least one conference call application.

11. The method of claim 7, further comprising determining a different one of the plurality of concurrent conference calls as a new foreground call based on content of the different one of the plurality of concurrent conference calls.

12. The method of claim 11, wherein the content comprises an audible mention of a name of a user of the information handling system.

13. An article of manufacture comprising a non-transitory, computer-readable medium having computer-executable instructions thereon that are executable by a processor of an information handling system, wherein the information handling system includes an audio input device, the instructions being executable for:
executing at least one conference call application, wherein the at least one conference call application is configured to join a plurality of concurrent conference calls;
determining one of the plurality of concurrent conference calls as a foreground call;
raising a volume level of the foreground call relative to another of the plurality of concurrent conference calls; and
transmitting audio input from the audio input device to the foreground call.

14. The article of claim 13, wherein the at least one conference call application comprises a plurality of different conference call applications.

15. The article of claim 13, wherein the at least one conference call application comprises a plurality of instances of a single conference call application.

16. The article of claim 13, wherein the instructions are further executable for:
receiving user input relating to settings for the at least one conference call application;
storing the user input in a database; and
transmitting the user input to the at least one conference call application.

17. The article of claim 13, wherein the instructions are further executable for determining a different one of the plurality of concurrent conference calls as a new foreground call based on content of the different one of the plurality of concurrent conference calls.

18. The article of claim 17, wherein the content comprises an audible mention of a name of a user of the information handling system.
